(19) United States
(12) Patent Application Publication
(10) Pub. No.: US 2025/0353704 A1
(43) Pub. Date: Nov. 20, 2025

(54) METHOD OF PROVIDING ACCESS TO AT LEAST ONE COMPONENT OF AN ELEVATOR SYSTEM AND ELEVATOR SYSTEM

(71) Applicant: Otis Elevator Company, Farmington, CT (US)

(72) Inventors: Romain Durand, Amilly (FR); Gerard Sirigu, Gien (FR)

(21) Appl. No.: 19/206,450

(22) Filed: May 13, 2025

(30) Foreign Application Priority Data
May 16, 2024 (EP) 24305769.2

(51) Int. Cl. B66B 11/02; B66B 1/06; B66B 1/34; B66B 5/00; B66B 13/14

(52) U.S. Cl. CPC B66B 11/0246; B66B 1/06; B66B 1/3461; B66B 5/0087; B66B 13/143

(57) ABSTRACT

An elevator system includes an elevator car configured for moving along a hoistway between a plurality of landings; a working platform, which is provided within the elevator car and convertible between a storage position and a working position; and a controller configured for controlling movement of the elevator car within the hoistway. The controller is switchable into a maintenance mode, in which it is configured for: moving the elevator car into a first maintenance position in which the working platform is accessible from the respective landing; opening a hoistway door at the respective landing and an elevator car door for allowing a person to convert the working platform from the storage position into the working position; and moving the elevator car into a second maintenance position for allowing a person to enter the working platform from the respective landing for accessing at least one component of the elevator system.

### FOREIGN PRIORITY

This application claims priority to European Patent Application No. 24305769.2, filed May 16, 2024, and all the benefits accruing therefrom under 35 U.S.C. § 119, the contents of which in its entirety are herein incorporated by reference.

### TECHNICAL FIELD OF INVENTION

The invention relates to a method of providing access to at least one component of an elevator system, in particular for providing access to at least on component which is/are arranged on top of and/or above an elevator car. The invention further relates to a method of maintaining an elevator system, and to an elevator system which allows providing access to at least one component of the elevator system, in particular for maintenance/repair purposes.

### BACKGROUND OF THE INVENTION

An elevator system comprises at least one elevator car configured for traveling along a hoistway between a plurality of landings located at different floors.

The elevator system typically comprises components which are arranged on top of the elevator car and/or above the elevator car at the upper end of the hoistway. From time to time, these components may need repair and/or maintenance.

Therefore, it would be beneficial to provide a method and an elevator system, which allow for an easy and convenient access to components which are arranged on top of the elevator car and/or above the elevator car at the upper end of the hoistway, in particular for maintenance/repair purposes.

### SUMMARY OF THE INVENTION

Exemplary embodiments of the invention include a method of providing access for a person, particularly a mechanic, to at least one component of an elevator system, which component is located on top of and/or above an elevator car of the elevator system, wherein the method includes: moving the elevator car along a hoistway, which extends between a plurality of landings, to a first maintenance position, such that a working platform, which is provided within the elevator car, is reachable by a person (mechanic) from a first one of the plurality of landings; opening an elevator car door and a hoistway door at the first one of the plurality of landings; accessing the elevator car from the first one of the plurality of landings for converting the working platform, which is provided within the elevator car, from a storage position into a working position within the elevator car; moving the elevator car along the hoistway to a second maintenance position, such that a person (mechanic) is capable of entering the working platform from a second one of the plurality of landings; entering the working platform by the person (mechanic); the person (mechanic) accessing the at least one component of the elevator system, which is located on top of and/or above the elevator car, from the working platform by reaching out through an upper portion of the elevator car.

Exemplary embodiments of the invention further include a method of maintaining an elevator system comprising the above mentioned method of providing access to at least one component of an elevator system.

Exemplary embodiments of the invention further include an elevator system comprising an elevator car, which is configured for moving along a hoistway between a plurality of landings; a working platform, which is provided within the elevator car and which is convertible between a storage position and a working position; and a controller, which is configured for controlling movement of the elevator car within the hoistway. The controller is switchable into a maintenance mode, in which it is configured for moving the elevator car into a first maintenance position in which the working platform is accessible for a person (mechanic) from a first one of the plurality of landings; opening, or allowing to open, a hoistway door at the first one of the plurality of landings and an elevator car door for allowing the person (mechanic) to convert the working platform from the storage position into the working position after the hoistway door and the elevator car doors are open; and moving the elevator car to a second maintenance position for allowing a person (mechanic) to enter the working platform from a second one of the plurality of landings for accessing the at least one component of the elevator system, which component is located on top of and/or above the elevator car, from the working platform by reaching out through an upper portion of the elevator car.

A method and an elevator system according to exemplary embodiments of the invention allow a person (mechanic) to access the at least one component of the elevator system, or a plurality of components of the elevator system, which is/are arranged on top of and/or above the elevator car, from a position within the elevator car fast and conveniently. Exemplary embodiments of the invention allow the person (mechanic) in particular to access such component(s) without having to enter the hoistway outside the elevator car. This reduces the risk of accidents and thus enhances the safety of the elevator system.

A number of optional features are set out in the following. These features may be realized in particular embodiments, alone or in combination with any of the other features.

When the elevator car is positioned in the second maintenance position, the difference in height between the working platform and the respective second one of the plurality of landings may be less than 25 cm, particularly less than 10 cm, more particularly less than 5 cm. This allows the person (mechanic) access or enter (or to step on) the working platform safely and conveniently from the second one of the plurality of landings. This also allows the person (mechanic) to leave or step off) the working platform safely and conveniently to the respective one of the plurality of landings which is associated with the second maintenance position. The height of the working platform refers to the height of a surface of the working platform on which the person (mechanic) is intended to stand after having entered the working platform. The height of the landing refers to the height of a surface of the landing adjacent to the door sill of the landing door.

When it is arranged in the working position, the working platform may extend basically horizontally within the elevator car for providing a safe and convenient support for a person (mechanic) stepping onto the working platform.

After the person (mechanic) has stepped onto the working platform, the elevator car may be moved to a third maintenance position within the hoistway. Said third maintenance position may in particular be at an upper end of the hoistway, allowing the person (mechanic) to conveniently access components located at the upper end of the hoistway.

The method may include opening the elevator car door and a hoistway door at the respective first one of the plurality of landings in order to allow a person (mechanic) to reach the working platform provided within the elevator car from said first one of the plurality of landings, and to convert the working platform from its storage position to its working position, or vice versa. The method may further include opening the elevator car door and a hoistway door at the respective second one of the plurality of landings in order to allow a person (mechanic) to enter the working platform, which is provided within the elevator car and converted into its working position, from said second one of the plurality of landings.

The first one of the plurality of landings may be the same as the second one of the plurality of landings. In this case, one person may conveniently provide both the converting of the working platform from its storage position to its working position and the entering of the working platform, which is provided within the elevator car and converted into its working position, in order to access the at least one component of the elevator system, which component is located on top of and/or above the elevator car, from the working platform by reaching out through an upper portion of the elevator car.

For enhancing the safety of the elevator system, the method may further include closing the elevator car door and/or the respective hoistway door(s) before moving the elevator car.

Alternatively, the method may include moving the elevator car without closing the elevator car door and/or at least some of the hoistway doors, in order to speed up the procedure.

The elevator car may comprise at least one service door or flap, in particular at least one service door or flap formed in an upper portion of the elevator car. The at least one service door or flap may be openable, allowing the person (mechanic) to reach out of the elevator car for accessing at least one component of the elevator system, which at least one component is located on top of and/or above the elevator car.

The method further may include opening such a service door or flap, formed in an upper portion of the elevator car, in order to allow the person (mechanic) to reach out of the elevator car for accessing the at least one component located on top of and/or above the elevator car.

Providing such a service door or flap in the elevator car may enhance the access to the at least one component even further.

According to a further exemplary embodiment, the method may include controlling the movement of the elevator car by control commands, which are entered via at least one input device. The at least one input device also may be denoted as control panel. The at least one input device may be located at one of the landings and/or within the elevator car. The at least one input device may in particular be a standard input device, which is also used for controlling the elevator system in normal operation.

The method may also include controlling the movement of the elevator car by entering control commands into a mobile control device, which is configured for transmitting the control commands to the controller of the elevator system. The mobile control device may in particular be configured for transmitting the control commands to the controller of the elevator system via wireless data transmission, such as WLAN (e.g. WiFi according to IEEE 802.11), Bluetooth, Bluetooth LE (Bluetooth Low Energy), or a similar communication protocol.

The mobile control device may be a dedicated mobile elevator control device, which is provided exclusively for controlling an elevator system. Such dedicated mobile elevator control device may be permanently coupled with the elevator system.

Alternatively, the mobile control device may be a commercial off-the-shelf mobile device, for example a smartphone or a tablet computer, running a suitable software, which allows the mobile control device to communicate with the controller of the elevator system. Using a commercial off-the-shelf mobile device avoids the need for designing and manufacturing a dedicated mobile elevator control device. This allows further reducing the costs for providing the mobile control device.

The elevator system may include a transceiver, which is configured for receiving control commands sent by a mobile control device for controlling the movement of the elevator car and for forwarding said control commands to the controller.

The controller, the transceiver and the mobile control device may be configured for bi-directional communication, allowing the controller to send feedback signals to the mobile control device. This may allow enhancing controlling the elevator system via the mobile control device.

The method may include entering a special command or code into the at least one input device, in particular for switching the controller of the elevator system into a maintenance mode, which allows manually controlling the movement of the elevator car and/or moving the elevator car to predefined maintenance positions, in particular to maintenance positions including the first, second and third maintenance positions mentioned above.

Controlling the movement of the elevator car and/or switching the controller into the maintenance mode may in particular require using a key. The key may be a mechanical key and/or an electronic key, for example an electronic key comprising an RFID-chip.

Such a key may prevent unauthorized persons from switching the controller into the maintenance mode and controlling the movement of the elevator car manually, which may be dangerous and/or disturb the normal operation of the elevator system.

After the person (mechanic) has accessed the at least one component of the elevator system by reaching out from an upper portion of the elevator car from the working platform, the method may further include: moving the elevator car to the second maintenance position; the person (mechanic) leaving the elevator car by stepping from the working platform onto the respective landing associated with the second maintenance position; moving the elevator car to the first maintenance position; and converting the working platform from its working position into its storage position. The step of moving the elevator car to the second maintenance position may be skipped, in case the elevator car has not been moved from the second maintenance position to the third maintenance position before.

These additional steps allows the person (mechanic) to safely and conveniently leave the elevator car and to convert the working platform back into its storage position, in which is does not obstruct passengers within the elevator car. After converting the working platform back into its storage position, the elevator system may be switched back into normal operation for conveying passengers between the plurality of landings.

In some embodiments, after the person (mechanic) has accessed the at least one component of the elevator system and is intended to leave the working platform, the elevator car may be moved to a second maintenance position which is associated with the same second one of the plurality of landings from which the person (mechanic) has entered the working platform. The person (mechanic) will thus return to the same landing as the landing from which the person (mechanic) entered the working platform. In other embodiments, after the person (mechanic) has accessed the at least one component of the elevator system and is intended to leave the working platform, the elevator car may be moved to a second maintenance position which is associated with a different second one of the plurality of landings than the second one from the plurality of landings from which the person (mechanic) has entered the working platform. The person (mechanic) will thus return to a different landing than the landing from which the person (mechanic) entered the working platform.

Also with respect to leaving the working platform, the first one of the plurality of landings may be the same as the second one of the plurality of landings. In this case, one person may conveniently provide both the entering of the working platform in order to access the at least one component of the elevator system, and the converting of the working platform from its working position to its storage position from the same one of the plurality of landings.

### BRIEF DESCRIPTION OF THE DRAWINGS

In the following an exemplary embodiment of the invention is described with reference to the enclosed figures.

FIG. 1 schematically depicts an elevator system according to an exemplary embodiment of the invention.

FIG. 2 schematically depicts the elevator system shown in FIG. 1 with the elevator car being positioned in a first maintenance position.

FIG. 3 schematically depicts the elevator system shown in FIGS. 1 and 2 with the elevator car being positioned in a second maintenance position.

FIG. 4 schematically depicts the elevator system shown in FIGS. 1 to 3 with the elevator car being positioned in the second maintenance position and a person (mechanic) entering the elevator car.

FIG. 5 schematically depicts the elevator system shown in FIGS. 1 to 4 with the elevator car being positioned in a third maintenance position and the person (mechanic) reaching out into the hoistway.

### DETAILED DESCRIPTION OF THE INVENTION

FIGS. 1 to 5 schematically depict an elevator system 2 according to an exemplary embodiment of the invention. The elevator system 2 comprises a hoistway 4 extending in a vertical direction between a plurality of landings 8a-8d. The landings 8a-8d are located on different floors of a building at different heights above a bottom 4a of the hoistway 4.

In the exemplary embodiment depicted in FIG. 1, the elevator system 2 comprises four landings 8a-8d. The skilled person understands that an elevator system 2 according to an exemplary embodiment of the invention may comprise more or less than four landings 8a-8d.

The elevator system 2 further comprises an elevator car 6, which is movably suspended within the hoistway 4 by means of a tension member 3. The tension member 3, for example a rope or belt, is coupled to an elevator drive system 5, including a motor and a drive that harnesses and controls the electrical energy sent to the motor. The elevator drive system 5 is configured for driving the tension member 3 in order to move the elevator car 6 along the longitudinal direction/height of the hoistway 4 between the plurality of landings 8a-8d.

In an alternative embodiment, which is not depicted in the figures, the elevator system 2 may be an elevator system 2 without a tension member 3, comprising e.g. a hydraulic drive system, or a linear motor for moving the elevator car 6.

The exemplary embodiment of the elevator system 2 shown in FIG. 1 employs a 1:1 roping for suspending the elevator car 6. The skilled person understands that the type of the roping is not essential for the invention and that different kinds of roping, e.g. a 2:1 roping, may be used as well.

Optionally, the elevator system 2 may further include a counterweight, which is not shown in FIG. 1, moving concurrently and in opposite direction with respect to the elevator car 6. Alternatively, the elevator system 2 may be an elevator system 2 without a counterweight, as it is depicted in FIG. 1.

The elevator system 2 may comprise at least one guide rail 16 for guiding the movement of the elevator car 6 along the hoistway 4.

Each landing 8a-8d is provided with at least one hoistway door 10, which also may be denoted as elevator hoistway door 10. The elevator car 6 is provided with at least one corresponding elevator car door 11, allowing passengers to transfer between a landing 8a-8d and the interior space of the elevator car 6, when the elevator car 6 is positioned at the respective landing 8a-8d.

The elevator drive system 5 is controlled by a controller 15, which is configured for controlling the movement of the elevator car 6 along the hoistway 4 between the plurality of landings 8a-8d.

Input to the controller 15 may be provided via landing control devices 7, which are located in the vicinity of the hoistway doors 10, and/or via an elevator car control device 9, which is located inside the elevator car 6.

The elevator system 2 may have a machine room housing the elevator drive system 5 and the controller 15. Alternatively, the elevator system 2 may be a machine room-less elevator system 2.

Further components 18, 19 of the elevator system 2, such as a governor, an elevator car position sensor, an elevator car speed sensor, a camera for monitoring the hoistway 4, etc., may be installed at an upper end 4b of the hoistway 4 and/or on top of the elevator car 6.

From time to time, these components 18, 19 may need repair and/or maintenance.

Exemplary embodiments of the invention provide a person (mechanic) 20 with easy and convenient access to components 18, which are installed at an upper end 4b of the hoistway 4 and/or components 19, which are installed on top of the elevator car 6.

For accessing such a component 18, 19, the person (in the following only referred to as “mechanic”) 20 provides input to the controller 15 of the elevator system 2 via one of the control devices 7, for switching the controller 15 into a maintenance mode and for instructing the controller 15 to move the elevator car 6 to a landing 8b at which the mechanic 20 is currently situated. In the exemplary embodiment depicted in FIG. 1, the mechanic 20 is situated at the second to lowest landing 8b.

Alternatively to using one of the control devices 7 provided at the landings 8a-8d of the elevator system 2, the mechanic 20 may use the elevator car control device 9 or a mobile control device 22, which communicates with the controller 15, for entering the special command. The mobile control device 22 may be configured to communicate wirelessly with the controller 15. The mobile control device 22 may, for example, communicate with the controller 15 using WLAN (WiFi), Bluetooth, Bluetooth LE, or a similar communication protocol.

The elevator system 2 may comprise a transceiver 28, which may be coupled to or formed integrally with the controller 15, and which may be configured for receiving control commands sent by the mobile control device 22 and for forwarding the received input commands to the controller 15.

Optionally, the controller 15, the transceiver 28 and the mobile control device 22 may be configured for bi-directional data transfer, allowing the controller 15 to send feedback signals to the mobile control device 22.

The mobile control device 22 may be a dedicated mobile elevator control device, which is provided exclusively for controlling the elevator system 2.

Alternatively, the mobile control device 22 may be a commercial off-the-shelf mobile device, for example a smartphone or a tablet computer, running a suitable software, which allows the mobile device to communicate with the controller 15.

For switching the controller 15 into the maintenance mode, the mechanic 20 may enter a special command, which may in particular include a secret code. Optionally, the mechanic 20 may need a mechanical or electronic key, for example an RFID-chip, for being allowed to enter such a special command.

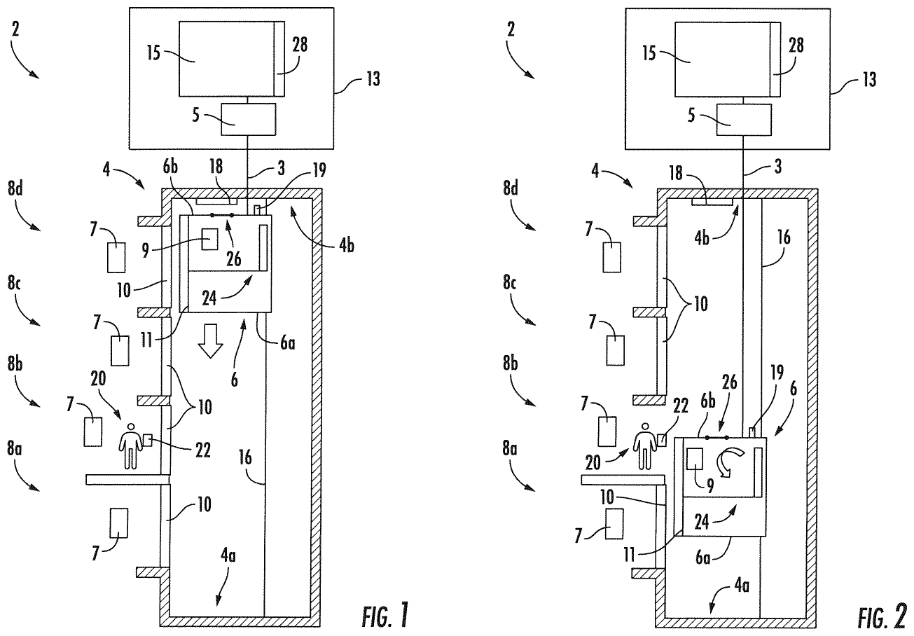

In the maintenance mode, the mechanic 20 may instruct the controller 15 to move the elevator car 6 into a first maintenance position, in which a working platform 24, which is provided within the elevator car 6, is accessible by the mechanic 20 from the respective landing 8b at which the mechanic 20 is located, as it is depicted in FIG. 2 (this landing is also referred to as the “first one of the plurality of landings”).

Depending on the configuration of the working platform 24 within the elevator car 6, the floor 6a (i.e. the bottom surface) of the elevator car 6 may be arranged below, above, or at the same height as, the respective landing 8b (i.e. the bottom surface of the landing 8b at the landing door sill), when the elevator car 6 is in the first maintenance position. In most configurations the floor 6a of the elevator car 6 will be located below the respective landing 8b. However it is to be understood that the only requirement of the first maintenance position is that the working platform 24, which is provided within the elevator car 6, is accessible by the mechanic 20 from the respective landing 8b at which the mechanic 20 is located, such that the mechanic 20 is able to convert the working platform from its storage position to its working position.

When the elevator car 6 is positioned in the first maintenance position, the floor 6a of the elevator car 6 may, for example, be arranged between 25 cm and 75 cm above or below the respective landing 8b. The floor 6a of the elevator car 6 may in particular be arranged between 25 cm and 50 cm above or below the respective landing 8b, or the floor 6a of the elevator car 6 may in particular be arranged between 50 cm and 75 cm above or below the respective landing 8b.

Alternatively, the floor 6a of the elevator car 6 may in particular be arranged flush with the respective landing 8b.

After the elevator car 6 has been positioned in the first maintenance position, the hoistway door 10 at the respective landing 8b and the elevator car door 11 are opened, allowing the mechanic 20 to access the working platform 24 within the elevator car 6 from the respective landing 8b.

The mechanic 20 then enters the elevator car 6, or reaches into the elevator car 6, and converts the working platform 24 from its storage position into its working position. When arranged in the working position, the working platform 24 may extend basically horizontally within the elevator car 6, as it is depicted in FIG. 2.

When arranged in the storage position, the working platform 24 may extend basically vertically parallel to the sidewalls of the elevator car 6, as it is depicted in FIG. 1. In such an embodiment, the working platform 24 may be pivoted between the storage position and the working position.

In an alternative embodiment, which is not explicitly depicted in the figures, the working platform 24 may extend basically horizontally in the storage position as well as in the working position. In such an embodiment, the working platform 24 may be moved linearly, for example using a scissor mechanism, in the vertical direction between the storage position and the working position.

The working platform 24 may be configured to be moved manually.

Alternatively, the elevator car 6 may be equipped with a motor for assisting the mechanic 20 in moving the working platform 24.

After the working platform 24 has been moved into the working position, the mechanic 20 inputs a further command, instructing the controller 15 to move the elevator car 6 into a second maintenance position, which allows the mechanic 20 to step easily onto the working platform 24. The second position may in particular be a position, in which the working platform 24 is positioned basically flush with the respective landing 8b, as it is depicted in FIG. 3.

When positioned in the second maintenance position, the difference in height between the working platform 24 and the respective landing 8b may be less than 25 cm, in particular be less than 10 cm, more particularly less than 5 cm.

In order to enhance the safety of the elevator system 2, the elevator car door 11 and the hoistway door 10 at the respective landing 8b may be closed before the elevator car 6 is moved from the first maintenance position into the second maintenance position. In this case, the elevator car door 11 and the hoistway door 10 may be opened again, after the elevator car 6 has been moved into the second maintenance position.

In an alternative embodiment, the elevator car door 11 and the hoistway door 10 may remain open when the elevator car 6 is moved, in order to speed up the procedure.

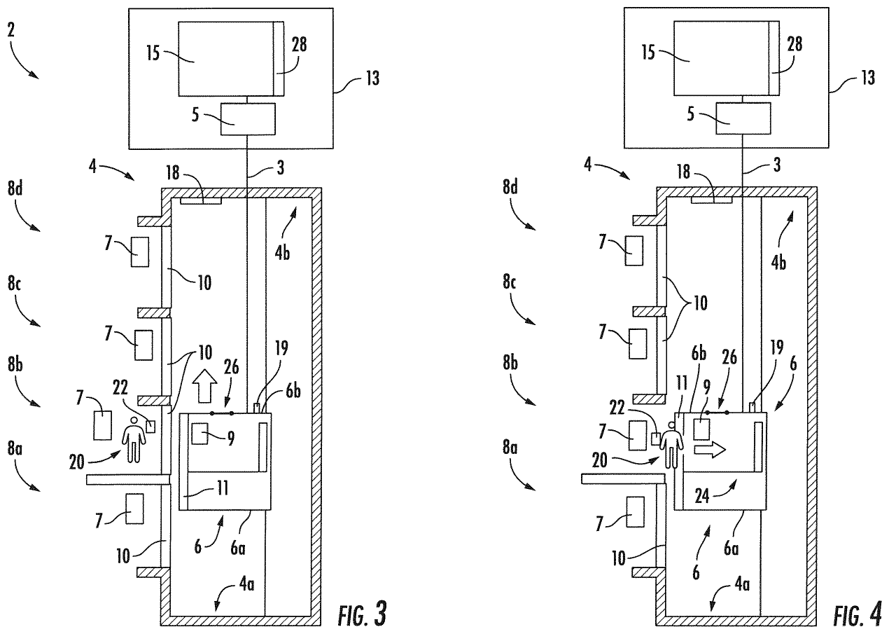

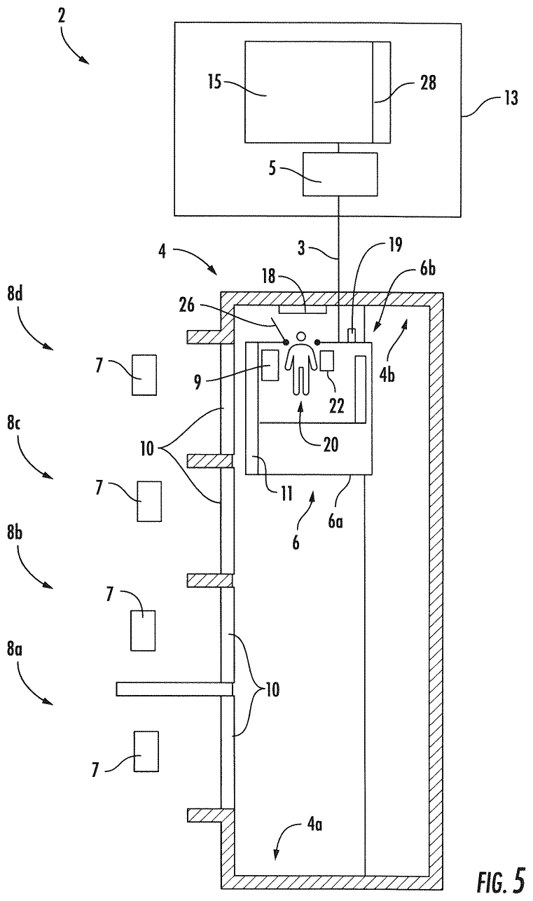

The mechanic 20 may then enter the elevator car 6 by stepping onto the working platform 24, as it is schematically depicted in FIG. 4.

After the mechanic 20 has entered the elevator car 6 and stepped onto the working platform 24, the mechanic 20 may input a further command instructing the controller 15 to move the elevator car 6 into a third maintenance position, in order to allow the mechanic 20 to access components 18, 19, which are arranged above or on top of the elevator car 6, as it is depicted in FIG. 5.

In order to access components 18, which are arranged above the elevator car 6, and/or components 19, which are arranged on top of the elevator car 6, the mechanic 20 may open a service door of flap 26, which is formed in an upper portion of the elevator car 6, allowing the mechanic 20 to reach out of the elevator car 6.

Moving the elevator car 6 from the second into the third maintenance position is optional. It may, for example, not be necessary to move the elevator car 6 into a third maintenance position for accessing components 19 that are arranged on top, in particular on the roof 6b, of the elevator car 6. It may further not be necessary to move the elevator car 6 from the second maintenance position into the third maintenance position if the elevator car 6 is already positioned at the uppermost landing 8d close to the upper end 4b of the hoistway 4, when it is arranged in the second maintenance position.

When the elevator car 6 is moved from the second maintenance position into the third maintenance position, the elevator car door 11 and the hoistway door 10 at the respective landing 8b may be closed before the elevator car 6 is moved, in order to enhance the safety of the elevator system 2.

In an alternative embodiment, the elevator car door 11 and the hoistway door 10 may remain open, when the elevator car 6 is moved, in order to speed up the procedure.

After the mechanic 20 has finished working on the component(s) 18, 19, the mechanic 20 may input a further control command, instructing the controller 15 to move the elevator car 6 from the third maintenance position, which is depicted in FIG. 5, back into the second maintenance position, which is depicted in FIG. 4.

After the elevator car 6 has been positioned in the second maintenance position, the mechanic 20 may leave the elevator car 6 by stepping from the working platform 24 onto the respective landing 8b.

After having left the elevator car 6, the mechanic 20 may input a command instructing the controller 15 to move the elevator car 6 from the second maintenance position into the first maintenance position, depicted in FIG. 2.

Optionally, the elevator car door 11 and all hoistway doors 10 may be closed during said movement.

After the elevator car 6 has been positioned in the first maintenance position, the mechanic 20 may access the elevator car 6 and convert the working platform 24 from the working position back into the storage position, in which it does not obstruct potential passengers within the elevator car 6.

After converting the working platform 24 into the storage position, the mechanic 20 may instruct the controller 15 to exit the maintenance mode and return to normal operation of the elevator system 2 for conveying passenger between the plurality of landings 8a-8d.

In the exemplary embodiment depicted in FIGS. 1 to 5, the mechanic 20 enters and leaves the elevator car 6 at the second to lowest landing 8b. Apparently, this is only one of multiple options.

The mechanic 20 may enter the elevator car 6 from any of the plurality of landings 8a-8d of the elevator system 2, after the elevator car 6 has been moved to the respective landing 8a-8d. The mechanic 20 may, in particular enter the elevator car 6 and the working platform 24 from the uppermost landing 8d, which is close to the upper end 4b of the hoistway 4. In this case, it may not be necessary to move the elevator car 6 from the second maintenance position into a third maintenance position, after the mechanic 20 has stepped onto the working platform 24, since the elevator car 6 is already positioned close to the upper end 4b of the hoistway 4.

This may allow the mechanic 20 to reach the components 18 located at the upper end 4b of the hoistway 4 by reaching out into the hoistway 4 through the upper portion of the elevator car 6 without moving the elevator car 6 into a third maintenance position above the second maintenance position. In consequence, the access to the components 18, 19 may be facilitated and accelerated even further.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention is not limited to the particular embodiments disclosed, but that the invention includes all embodiments falling within the scope of the claims.

What is claimed is:

1. A method of providing access for a person (20) to at least one component (18, 19) of an elevator system (2), which at least one component (18, 19) is located on top of and/or above an elevator car (6) of the elevator system (2), wherein the method includes:
moving the elevator car (6) along a hoistway (4), which extends between a plurality of landings (8a-8d), to a first maintenance position, such that a working platform (24), which is provided within the elevator car (6), is reachable by a person (20) from a first one of the plurality of landings (8a-8d);
opening an elevator car door (11) and a hoistway door (10) at the first one of the plurality of landings (8a-8d);
accessing the elevator car (6) from the first one of the plurality of landings (8a-8d) and converting the working platform (24) from a storage position to a working position within the elevator car (6);
moving the elevator car (6) along the hoistway (4) to a second maintenance position, such that a person (20) is capable of entering the working platform (24) from a second one of the plurality of landings (8a-8d);
entering the working platform (24) by the person (20) from the second one of the plurality of landings (8a-8d);
accessing, by the person (20), the at least one component (18, 19) of the elevator system (2) from the working platform (24) by reaching out through an upper portion of the elevator car (6).

2. The method according to claim 1, wherein the first one of the plurality of landings (8a-8d) is the same as the second one of the plurality of landings (8a-8d).

3. The method according to claim 1, wherein, when the elevator car (6) is positioned in the second maintenance position, a difference in height between the working platform (24) and the second one of the plurality of landings (8a-8d) 8b is less than 25 cm, particularly less than 10 cm, more particularly less than 5 cm.

4. The method according to claim 1, wherein the method includes, after the person (20) has entered the working platform (24), moving the elevator car (6) to a third maintenance position within the hoistway (4); wherein the third maintenance position is in particular at an upper end (4b) of the hoistway (4) such as to allow the person (20) on the working platform (24) to access the at least one component at the upper end (4b) of the hoistway (4).

5. The method according to claim 1, wherein the method includes closing the elevator car door (11) and/or the respective hoistway door (10) before moving the elevator car (6) from the first and/or second maintenance position.

6. The method according to claim 1, wherein the method includes opening a service door or flap (26) formed in an upper portion of the elevator car (6) in order to allow the person (20) on the platform (24) to reach out of the elevator car (6) for accessing the at least one component (18, 19).

7. The method according to claim 1, wherein the method includes controlling movement of the elevator car (6) by control commands entered via at least one input device, wherein the at least one input device is located at the elevator car (6) and/or at at least one the landings (8a-8d); and/or wherein the method includes controlling movement of the elevator car (6) by control commands entered into a mobile control device (22) configured for transmitting the control commands to the controller (15) of the elevator system (2).

8. The method according to claim 7, wherein the method includes controlling movement of the elevator car (6) by entering a special code into the at least one input device or into the mobile control device (22), respectively, and/or wherein controlling movement of the elevator car (6) includes using a key, wherein the key is in particular a mechanical key and/or an electronic key.

9. The method according to claim 1, wherein the method further includes, after the person (20) has accessed the at least one component (18, 19) of the elevator system (2) from the working platform (24):
moving the elevator car (6) to the second maintenance position;
the at least one person (20) leaving the elevator car (6) by stepping from the working platform (24) onto the respective landing (8a-8d);
moving the elevator car (6) to the first maintenance position; and
converting the working platform (24) from its working position to its storage position.

10. A method of maintaining at least one component of an elevator system, which at least one component (18, 19) is located on top of and/or above an elevator car (6) of the elevator system (2), the method comprising providing access for a person (20) to the at least one component as claimed by claim 1.

11. An elevator system (2) comprising
an elevator car (6), which is configured for moving along a hoistway (4) between a plurality of landings (8a-8d);
a working platform (24), which is provided within the elevator car (6) and which is convertible between a storage position and a working position; and
a controller (15), which is configured for controlling movement of the elevator car (6) within the hoistway (4);
wherein the controller (15) is switchable into a maintenance mode, in which it is configured for:
moving the elevator car (6) to a first maintenance position in which the working platform (24) is accessible from a first one of the plurality of landings (8a-8d);
opening an elevator car door (11) and a hoistway door (10) at the first one of the plurality of landings (8a-8d) for allowing a person (20) to convert the working platform (24) from the storage position to the working position; and
moving the elevator car (6) to a second maintenance position for allowing a person (20) to enter the working platform (24) from a second one of the plurality of landings (8a-8d) for accessing the at least one component (18, 19) of the elevator system (2), which is located on top of and/or above the elevator car (6), from the working platform (24) by reaching out through an upper portion of the elevator car (6).

12. The elevator system (2) according to claim 11, wherein the first one of the plurality of landings (8a-8d) is the same as the second one of the plurality of landings (8a-8d); and/or wherein, when the elevator car (6) is positioned in the second maintenance position, the difference in height between the working platform (24) and the second one of the plurality of landings (8a-8d) is less than 25 cm, particularly less than 10 cm, more particularly less than 5 cm.

13. The elevator system (2) according to claim 11, wherein the controller (15) is further configured for moving the elevator car (6) to a third maintenance position after the person (20) has entered the working platform (24), wherein the third maintenance position is in particular at an upper end (4b) of the hoistway (4) allowing the person (20) to access the at least one component at the upper end (4b) of the hoistway (4) from the working platform (24).

14. The elevator system (2) according to claim 11, wherein the elevator car (6) comprises at least one service door or flap (26) formed in an upper portion of the elevator car (6), wherein the at least one service door or flap (26) is configured to be opened by the person (20) on the working platform (24) to reach out of the elevator car (6) for accessing the at least one component (18, 19) of the elevator system (2), which is located on top of and/or above the elevator car (6).

15. The elevator system (2) according to claim 11, wherein the controller (15) is further configured for allowing to open, or opening, an elevator car door (11) and a hoistway door (10) at the first one and/or second one of the plurality of landings (8a-8d) such as to allow the person (20) to access the elevator car (6), wherein the controller (15) is in particular configured for allowing to close, or closing, the elevator car door (11) and the at least one of the hoistway doors (10) at the first one and/or second one of the plurality of landings before the elevator car (6) is moved; and/or wherein the elevator system (2) includes at least one control device (7, 9), which is provided at at least one of the landings (8a-8d) and/or within the elevator car (6), and which is configured for receiving control commands for controlling the movement of the elevator car (6) and/or wherein the elevator system (2) includes a transceiver (28), which is configured for receiving control commands sent by a mobile control device (22) for controlling the movement of the elevator car (6).
